(19) United States
(12) Patent Application Publication
(10) Pub. No.: US 2024/0240875 A1
(43) Pub. Date: Jul. 18, 2024

(54) Thermal Energy Storage And Method For Controlling A Thermal Energy Storage

(71) Applicant: Hydroc Energy Storage AB, Göteborg (SE)

(72) Inventors: Sven-Åke LARSSON, Göteborg (SE); Bo BERGMAN, Göteborg (SE); Nils OLOFSSON, Göteborg (SE); Timo POHJANVUORI, Hovås (SE); Jan BERGLAND, Göteborg (SE)

(21) Appl. No.: 18/561,974

(22) PCT Filed: Jun. 9, 2022
(86) PCT No.: PCT/SE2022/050567

§ 371 Date: Nov. 17, 2023

(30) Foreign Application Priority Data
Jun. 11, 2021 (SE) 2150755-3

(51) Int. Cl. F28D 20/00

(52) U.S. Cl. CPC F28D 20/0052; F28D 2020/0069

(57) ABSTRACT

The invention relates to a thermal energy storage having a fluid source comprising one or more primary boreholes (110; 210; 311, 312, 313; 411, 412, 413; 511; 611; 711; 811; 911) extending from ground level to a predetermined depth in a rock body; and one or more secondary boreholes (120; 220; 751; 851; 951) located remote from the fluid source. At least an upper and a lower fracture plane (P₁, P₂, P₃) intersects the one or more primary boreholes (110; 210; 311, 312, 313; 411, 412, 413; 511; 611; 711; 811; 911) and said secondary boreholes (120; 220; 751; 851; 951), which fracture planes (P₁, P₂, P₃) permit a hydraulic flow of fluid between the primary borehole and at least one of the secondary boreholes (120; 220; 751; 851; 951). The fluid source comprises a well system comprising at least two wells (311, 312, 313; 431, 432, 433; 531, 532, 533; 631, 632, 633; 731; 831, 832, 833; 931) where each well is in fluid communication with one or more fracture planes; and where at least one sealing element positioned to prevent hydraulic flow between wells. The hydraulic flow in each well is controllable to permit a hydraulic flow of fluid between one or more primary boreholes (110; 210; 311, 312, 313; 411, 412, 413; 511; 611; 711; 811; 911) and at least one of the secondary boreholes (120; 220; 751; 851; 951) in at least one fracture plane (P₁, P₂, P₃).

### TECHNICAL FIELD

The invention primarily relates to a thermal energy storage for storing energy in the form of heat in a rock formation. More specifically, the invention relates to a method of storing heat from periods when excess energy is available to periods when it is desirable to recover the stored heat. The storage can work both as a short-term storage and as a long-term storage with annual variations. In one example, the heat storage is charged over a number of months during the summer and the accumulated heat can be discharged in cold periods during the winter. Alternatively, the thermal energy storage can be used for storing cold, wherein cold is stored during the winter for subsequent discharge during the summer for the purpose of cooling buildings etc. The invention likewise relates to a method for controlling such a heat storage.

### BACKGROUND OF THE INVENTION

The need for energy storage in the form of heat or cold, has increased significantly over time, primarily called for by the development of alternative energy sources such as solar and wind energy but also for recovering excess and waste heat or cold from commercial and industrial facilities. Against this background, a number of systems have been proposed for accumulating energy in bodies of rock.

The need for energy storage primarily exists in areas with high energy consumption as urban, built up areas where they can be adapted for diurnal or seasonal energy usage, allowing heat or cold to be stored for later re-use. Suitable use for energy stored in this way includes control of the indoor environment in offices, shopping centres, hospitals, greenhouses and housing in general. Stored energy can be used for heating public spaces in the winter and/or cooling them in the summer. The source of heat can be waste heat from air conditioning units or cooling machines during periods of higher ambient temperatures. Waste heat from manufacturing processes or heat/electricity generating plants is also suitable for this purpose. Alternatively, the source of cold can be the cold section of heat exchangers or heat pumps used for heating purposes during periods of lower ambient temperatures.

Thermal energy storage installations are especially well suited for urban areas as the distance between different buildings is relatively small, which facilitates distribution and equalization of thermal energy. Urban areas will also have a relatively high degree of existing networks for district heating/cooling, allowing for large-scale energy exchange between different types of buildings and properties.

SE429262 describes an installation for thermal energy storage. In this example, a storage for storing heat in rock is produced by fracturing the rock hydraulically in approximately plane parallel fissure planes from a number of boreholes. A number of production holes and infiltration boreholes are drilled down to the bottom of the cracked store. Hot water is supplied to the system from the infiltration boreholes, where after the water flows through the store along flow paths defined by the fractured planes and transverse channels towards one or more production holes. This type of facility has a relatively large capacity and provides a large surface area in relation to the number of holes drilled.

A problem with the above solution is that charging and discharging of the thermal energy storage is performed for the entire volume at once. During charging this requires a relatively constant supply of heated water over an extended period of time in order to achieve a desired temperature gradient throughout all the fracture planes in the storage. Similarly, during discharging a production facility receiving heated water from the storage must be able to process and utilise a constant supply of heated water over an extended period of time. Intermittent operation of a thermal energy storage of this type is undesirable due to the limited flow rate through the fracture planes. A problem with intermittent stopping and starting of the charging or discharging process is that it will cause undesirable variations in the thermal gradient through the fracture planes, which will have a negative effect on the efficiency of the storage. Also, a factor to consider is temperature difference ΔT across the fracture planes of the storage, between the infiltration holes and the production hole. If the entire thermal energy storage is charged, then the time period required before the storage can be discharged with a relatively high ΔT will be excessive.

The object of the invention is to provide an improved thermal energy storage and a method for controlling a thermal energy storage that solves the above problems.

### Invention

The above problems have been solved by a method as claimed in the appended claims.

In the subsequent text, the term “thermal energy storage” is intended to describe an arrangement allowing a liquid medium, usually in the form of hot or cold water, to be transferred from the surface into an underground storage facility in a rock body where the medium will heat or cool the rock body containing the thermal energy storage. Stored heat or cold can subsequently be transferred back to the surface by discharging the liquid medium from the thermal energy storage. The thermal energy storage is also referred to as a “storage”. Each storage volume can comprise at least one production borehole, which will also be referred to as a “primary borehole”. The term “fluid source” will be used as collective term to denote all embodiments from single primary boreholes forming individual wells comprising multiple wells, to multiple primary boreholes each forming an individual well or comprising multiple wells. In this context, the production borehole(s) is considered to form a fluid source supplying heat to the thermal storage during charging. During discharging, the production borehole(s) is considered to form a fluid source supplying heat from the thermal storage to a production facility above ground. The term “well” is used to denote a conduit for supplying or withdrawing water from a one or more fracture planes associated with the well. In this context, a primary borehole can form a well. Alternatively, a well can be a pipe extending down to one or more associated fracture planes. According to a further alternative, a single pipe can be provided with one or more controllable valves in order to function as multiple wells. Further, a set of boreholes located at the periphery of, or within fracture planes associated with a fluid source or a production borehole will be referred to as a “secondary boreholes”. Each set of secondary boreholes comprises at least two drilled holes extending from ground level to a predetermined depth in the rock body and intersecting at least one fractured plane. Although a minimum of two drilled holes per set of secondary boreholes is possible within the scope of the invention, it is preferable to provide three or more secondary boreholes per set in order to create a more distinct storage volume about the at least one primary borehole. The use of three or more secondary boreholes per set will also allow the fracture planes to be utilized more effectively. The set of secondary boreholes can be located equidistant, or at least distributed around the at least one primary borehole at fractured plane level when possible. Variations in numbers and/or the distribution can be caused by a number of factors, such as fracture plane aperture distribution, fracture plane water flow pressure loss distribution, fracture plane radial distribution or by an active selection of the borehole position to enable a secondary borehole to reach a particular fracture plane or to avoid obstacles, such as local infrastructure or an undesirable rock formation. Fracture planes and apertures will be described in further detail below.

A thermal storage suitable for use with the invention can comprise different types of storage volumes. According to one example, the thermal energy storage comprises at least one primary borehole extending substantially vertically from ground level to a first predetermined depth in a rock body, wherein at least two fracture planes extending away from the at least one primary borehole are produced at different depths and at a suitable vertical spacing. At least one set of secondary boreholes are located in a cluster adjacent the at least one primary borehole at ground level. From ground level, the secondary boreholes are drilled to intersect an upper and a lower fracture plane, which extend in a radial and/or oblique plane from the at least one primary borehole towards adjacent secondary boreholes. The secondary boreholes can be located in a cluster adjacent the primary borehole either around it in an equidistant or a more or less evenly distributed pattern, or in one or more clusters of two or more boreholes to at least one side of and substantially parallel to the primary borehole. A similar thermal energy storage is described in SE 429 262 (B).

According to a second example, the thermal energy storage comprises at least one primary borehole extending downwards in a vertical direction, or at an acute angle to the vertical direction, relative to a horizontal plane at ground level. The angle of each primary borehole is selected dependent on factors such as local geological conditions, underground infrastructure, available drilling site position relative to a suitable rock body and/or the number and relative positions of individual planned storage volumes. For instance, the angle of a primary borehole can be adapted, but not limited to the local stress direction controlling fracture planes in the rock body in order to achieve fracture planes in a substantially radial direction from the primary borehole. This will result in an increased distance between the primary borehole and the secondary boreholes located on either side of the primary borehole in the direction of the incline. In order to maintain a desired flow, additional fracturing can be required to achieve an increase in fracture plane aperture with increasing depth. The set of secondary boreholes is drilled to diverge from the primary borehole(-s), at least between an upper fracture plane and a lower fracture plane, with increasing depth. The secondary boreholes and the upper and lower fracture planes can be said to define a fractured, artificial storage volume surrounding the at least one primary borehole. A suitable thermal energy storage of this type is described in the Swedish patent application SE2050997-2 (A).

The total volume comprises the artificial storage volume where forced circulation of water occurs and an additional volume of the rock body surrounding the storage volume. The rock body making up the additional volume should preferably, but not necessarily, be as dense and homogeneous as possible. Undeformed granite is a typical example of this type of rock formation. The additional volume surrounding the storage volume is heated or cooled by conduction from hot or cold water circulating through the storage volume and can provide a substantial addition to the capacity of the thermal energy storage. Also, the fracture planes will as a rule extend beyond the secondary boreholes and into the additional volume. The flow of water through the portions of the fracture planes extending past the secondary boreholes will be negligible compared to the total flow through the artificial storage volume, but it will contribute to the heating or cooling of the additional volume.

The size of the storage volume, the number of fracture planes within each storage volume and the spacing between adjacent fracture planes is determined by considering a number of factors. A non-exhaustive list of such factors include the heat-conducting capacity of the rock, the cumulative aperture area of all fracture planes required for a desired flow and pressure, the total surface area of the fracture planes, the temperature of the water to be supplied during charging, the desired flow rate to be withdrawn during discharging, charging cycle time and the desired storage capacity of the thermal energy storage.

The desired heat transfer capacity of a storage volume is mainly dependent on the conductive properties of the rock body, the annual average temperature of the rock body relative to the temperature of the fluid/water used for charging the storage and on the cumulative surface area of all fracture planes.

The annual average temperature of the rock body is dependent on the geographical location of the thermal energy storage and the depth of the storage volume. The location and depth is preferably selected to provide annual average temperature in the range 4-10° C. throughout the storage volume. As the circulating fluid used is water, ambient rock temperatures at or near freezing temperatures must be avoided. In areas with a relatively cold climate or in areas with permafrost the storage volume can be located at a greater depth, compared to areas with a relatively warm climate.

The surface area of each fracture plane is made up of all cracks and fissures extending both in radial directions from the primary borehole and in vertical directions out of the fracture plane. The desired the flow rate of a storage volume is mainly dependent on the cumulative aperture area and the radial extension of all fracture planes from the primary boreholes. Both the surface area and the aperture area of each fracture plane can to a large extent be controlled when performing hydraulic fracturing during construction of the thermal energy storage.

As indicated above, the hydraulic fracturing step can be performed before or after the drilling of secondary boreholes. When hydraulic fracturing is performed before the secondary boreholes are drilled, then the pressure and flow will cause fissures in the rock to open up and the fracture plane to extend outwards from the pressurized section of primary borehole as far as can be achieved by the applied pressure. This allows the distribution and extent of a fracture plane to be monitored and mapped, which data can be used for optimal positioning of the secondary boreholes during subsequent drilling. Both the distribution and number of secondary boreholes can be adapted in view of the distribution and extent of the fracture planes within a storage volume.

When hydraulic fracturing is performed after the secondary boreholes are drilled, then the pressure will cause the fracture plane to extend outwards from the pressurized section of primary borehole and substantially up to the secondary boreholes. During a subsequent hydraulic fracturing step, the extension of the fracture planes can be limited due to the presence of the secondary borehole which causes a loss of pressure. This allows for an intentional limitation in the extension of the fracture planes in a storage volume in cases when it is desirable to control and/or limit the distribution and extent of the fracture planes. This can be the case when multiple storage volumes are constructed side-by-side or when it is necessary to avoid fracturing in adjacent rock bodies containing existing structures.

According to one aspect, the invention relates to a thermal energy storage comprising:
a fluid source comprising one or more primary boreholes extending from ground level to a predetermined depth in a rock body;
one or more secondary boreholes located remote from the fluid source; and
at least an upper and a lower fracture plane intersecting the one or more primary boreholes and said secondary boreholes, which fracture planes permit a hydraulic flow of fluid between the primary borehole and at least one of the secondary boreholes.

The fluid source comprises a well system having at least two wells where each well is in fluid communication with one or more fracture planes. The well system comprises at least one sealing element positioned to prevent hydraulic flow between wells. At least one pump is operable to pressurize the fluid and effect a hydraulic flow between one or more primary boreholes and at least one of the secondary boreholes. The hydraulic flow in each well is controllable to permit a hydraulic flow of fluid between one or more primary boreholes and at least one of the secondary boreholes in at least one fracture plane.

The hydraulic flow direction through a fractured plane is determined by at least one pump selected for operation. The flow direction can be selected in the direction to or from one or more wells in at least one of the primary boreholes. During charging, one or more pumps can be operated to cause heated water to flow from one or more wells in at least one of the primary boreholes towards one or more secondary boreholes.

According to one example, a pump is arranged in at least one of the secondary boreholes. According to a further example, a pump is connected to at least one of the wells. Combinations of pumps in at least one of the secondary boreholes and at least one of the wells are also possible within the scope of the invention. Specific examples of such arrangements will be described in connection with the drawings. According to a preferred example, submersible pumps are used for this purpose. Such a pump is advantageously located at or preferably, below the level of an adjacent fracture plane.

A thermal energy storage according to the invention can comprise a well system having one or more wells or well arrangements, as will be outlined below.

According to a first example, the thermal energy storage comprises a well system where each well is a primary borehole extending past one or more intermediate fracture planes which well is separated from each intermediate fracture plane by an annular sealing element located level with each intermediate fracture plane. In this way, each primary borehole forms a well that is in fluid connection with a fracture plane or a group of adjacent fracture planes. In order to prevent flow from a primary borehole into a fracture plane not associated with said primary borehole, an annular sealing element comprising, for instance, concrete is placed around the inner perimeter of the primary borehole level with the fracture plane intersecting the primary borehole. Consequently, fluid communication between the primary borehole and any intermediate fracture planes can be prevented. Separate primary boreholes, each forming individual a well at different depths, are provided for each fracture plane or group of adjacent fracture planes throughout the storage volume.

According to a second example, the thermal energy storage comprises a well in the form of a pipe extending to and/or past one or more intermediate fracture planes to its respective fracture plane or planes and where a sealing element is arranged between the pipe and the primary borehole below the lowermost intermediate fracture plane. In this way, each primary borehole comprises a well that is in fluid connection with a fracture plane or a group of adjacent fracture planes. In order to prevent flow from the well into a fracture plane not associated with said primary borehole, an annular sealing element is placed in the gap between the inner perimeter of the primary borehole and the outer surface of the pipe. The annular sealing element is positioned above the fracture plane or group of adjacent fracture planes associated with said well and below the any intermediate fracture plane. Consequently, fluid communication between the well and any intermediate fracture planes can be prevented. Separate primary boreholes, each with a pipe forming an individual well at different depths, are provided for each fracture plane or group of adjacent fracture planes throughout the storage volume.

According to a third example, the thermal energy storage comprises a primary borehole with a well system in the form of at least one pipe that extends to two or more fracture planes. The at least one pipe comprises controllable valves each operable to form an individual well in fluid communication with one or more fracture planes. Each well is separated from other wells in the primary borehole by at least one sealing element arranged between the pipe and the primary borehole. In this way, a single pipe can form multiple wells, where each well is in fluid connection with a fracture plane or a group of adjacent fracture planes. In other words, when a valve is opened, the pipe section extending from ground level down to the opened valve forms a well. The valves are controllable individually to supply a single fracture plane or group of adjacent fracture planes, or together to supply several single fracture planes or groups of adjacent fracture planes. In order to prevent flow from the well into a fracture plane not associated with said well, an annular sealing element is placed in the gap between the inner perimeter of the primary borehole and the outer surface of the pipe. An annular sealing element is positioned above each valve, above the fracture plane or group of adjacent fracture planes associated with said valve and below the nearest intermediate fracture plane above the valve. Consequently, fluid communication between the valve forming a well and adjacent fracture planes can be prevented. A primary borehole can comprise more than one pipe with one or more valves forming individual wells at different depths, in order to supply each fracture plane or group of adjacent fracture planes throughout the storage volume.

According to a fourth example, the thermal energy storage comprises well system where individual wells extend into a primary borehole to one or more fracture planes. Each well is separated from other wells in the primary borehole by at least one sealing element arranged between the inner perimeter of the primary borehole and the outer surface of the pipe. In this way, every well comprises a single pipe, where each well is in fluid connection with a fracture plane or a group of adjacent fracture planes. In order to prevent flow from the well into a fracture plane not associated with said well, an annular sealing element is placed in the gap between the inner perimeter of the primary borehole and the outer surface of the pipe. An annular sealing element is positioned above the fracture plane or group of adjacent fracture planes associated with said well and below the nearest intermediate fracture planes above the well. Consequently, fluid communication between the valve forming a well and adjacent fracture planes can be prevented. A primary borehole can comprise more than one pipe with one or more valves forming individual wells at different depths, in order to supply each fracture plane or group of adjacent fracture planes throughout the storage volume. If a primary borehole comprises more than one sealing element, wells extending from ground level to the lowermost fracture plane or planes can pass through more than one sealing element.

A thermal energy storage according to the invention can also be provided with a fluid source comprising a combination of two or more well systems as described above.

A thermal energy storage according to the above examples can comprise a pump in at least one secondary borehole. The pump is operable to pump fluid out of its secondary borehole and up to ground level in order to generate a hydraulic flow in a direction from a well located in a primary borehole towards the secondary borehole. According to a first example, if a pump is located in each secondary borehole then the pumps are operable to generate a hydraulic flow from the well into an entire fracture plane, or a group of fracture planes. The fracture plane is selectable by controlling a valve that opens a flow of heated water to the well associated with the fracture plane to be charged. Such a valve can be located at ground level or in the primary borehole, depending on the well system provided. Alternatively, or in combination, a further pump connected to the well can be operated to achieve a desired fluid flow rate into the fracture plane.

According to a second example, the pumps in each individual secondary borehole are selectively operable to generate a hydraulic flow into a sector of a fracture plane from a well connected to a supply of fluid to each selected secondary borehole. As in the first example, the fracture plane is selectable by controlling a valve that opens a flow of heated water to the well associated with the fracture plane or fissure plane to be charged. Such a valve can be located at ground level or in the primary borehole, depending on the well system provided.

Alternatively, or in combination, a further pump connected to the well can be operated to achieve a desired fluid flow rate into the fracture plane. The desired sector of the selected fracture plane is in turn selected by the operation of one or more pumps in individual secondary boreholes. In this way, heated water will only flow from the fracture plane of the selected well into a sector of that sector plane located between the well and the secondary borehole or boreholes wherein the pumps are operated.

The above examples are suitable for use when a limited supply of heated water is available for charging the thermal energy storage. When a sufficiently large and constant supply of heated water is available over an extended period of time, it is of course possible to open several or all wells and operate the pumps in all the secondary boreholes to charge multiple or all fracture planes. The arrangements described above makes the thermal energy storage very flexible as it can be charged at any rate, from a partial charging of a sector of a fracture plane to a complete charging of the entire storage volume, depending on the current supply of heated water.

In addition to the above examples, a pump located in a secondary borehole is further operable to pump fluid from ground level and into its secondary borehole in order to generate a hydraulic flow in a direction from the secondary boreholes towards a well located in a primary borehole. According to a first example, if a pump is located in each secondary borehole then the pumps are operable to generate a hydraulic flow from all secondary boreholes into an entire fracture plane, or a group of fracture planes. The fracture plane is selectable by controlling a valve that allows a flow of stored heated water out of the well associated with the fracture plane to be charged. Such a valve can be located at ground level or in the primary borehole, depending on the well system provided. Alternatively, or in combination, a further pump connected to the well can be operated to achieve a desired fluid flow rate from the fracture plane and up to ground level.

According to a second example, the pumps in each individual secondary borehole are selectively operable to generate a hydraulic flow from a sector of a fracture plane towards a well connected to the fracture plane. As in the first example, the fracture plane is selectable by controlling a valve that allows a flow of heated water towards the well associated with the fracture plane or fissure plane to be discharged. Such a valve can be located at ground level or in the primary borehole, depending on the well system provided. Alternatively, or in combination, a further pump connected to the well can be operated to achieve a desired fluid flow rate from the fracture plane to ground level. The desired sector of the selected fracture plane or planes is in turn selected by the operation of one or more pumps in individual secondary boreholes. In this way, heated water will only flow towards the selected well from a sector of the fracture plane associated with the selected secondary boreholes where the pumps are operated.

The above examples are suitable for use when a limited supply of heated water needs to be discharged from the thermal energy storage. When a larger, constant supply of heated water is required over an extended period of time, it is of course possible to open several or all wells and operate the pumps in all the secondary boreholes to discharge multiple or all fracture planes. The arrangements described above makes the thermal energy storage very flexible as it can be discharged at any rate, from a partial discharge using a sector of a fracture plane to a complete discharge of the entire storage volume, depending on the current demand for heated water.

Thermal energy storage arrangements according to the above examples allow a liquid medium in the form of hot or cold water to be transferred from the surface into an underground storage facility in a rock body where the medium will heat or cool the rock body containing the thermal energy storage. Stored heat or cold can subsequently be transferred back to the surface by discharging the liquid medium from the thermal energy storage. Further, different fracture planes throughout the storage can be charged individually with either cold or hot water, allowing the storage to be used as a source of heat or cold depending on the current requirements. Heat and/or cold can be stored over different time periods such as years or months, depending on seasonal variations. For instance, heat stored during summer periods can be retrieved during a subsequent winter period, and vice versa. The periodicity can be varied for different fracture planes, for different sectors in different fracture planes, or even for different sectors within the same fracture plane. Hot or cold water can be charged into the storage or be withdrawn from the storage by controlling the flow through the entire storage volume, through one or more fracture planes or through one or more sectors in one or more fracture planes.

In addition, different fracture planes or different sectors can be charged and/or discharged with respect to the delta temperature ΔT available at the time of charging/discharging. In this context, the term delta temperature or ΔT is defined as the temperature difference across the fracture planes of the storage. During charging ΔT is the temperature difference between the water supplied to the primary borehole(s) and the water pumped out of the secondary borehole(s). Similarly, during discharging ΔT is the temperature difference between the water pumped out of the primary borehole(s) and the water supplied to the secondary borehole(s). For instance, when a source of water can deliver water with a relatively high ΔT then this can be used for charging one or more fracture planes or one or more sectors thereof, depending on the supplied volume and flow rate. When a source of water can deliver water with a relatively low ΔT then this can be used for charging one or more different fracture planes or one or more sectors thereof, depending on the supplied volume and flow rate. In this way, different fracture planes and/or sectors can be charged using water having different ΔT.

During a later discharge, it is possible to select one or more fracture planes or one or more sectors having a ΔT suitable for a particular purpose. The periodicity used for charging and/or discharging of the fracture planes or sectors can also be different for individual fracture planes or sectors. Suitable temperatures for heated water can be in the range 20-100° C., depending on the source of the heated water, Temperatures above 100° C. are possible, although this will require pressurization of the water in the primary borehole to avoid steam formation. Suitable temperatures for the cold water can be in the range 1-10° C., depending on the source of cold water. Note that the above temperature ranges are listed as suitable examples only.

According to a second aspect, the invention relates to a method for controlling a thermal energy storage comprising a fluid source comprising one or more primary boreholes extending from ground level to a predetermined depth in a rock body, one or more secondary boreholes located remote from the fluid source, and at least an upper and a lower fracture plane intersecting the one or more primary boreholes and said secondary boreholes, which fracture planes permit a hydraulic flow of fluid between the primary borehole and at least one of the secondary boreholes. The above-mentioned fluid source comprises a well system comprising at least two wells where each well is in fluid communication with one or more fracture planes. Further, the well system comprises at least one sealing element positioned to prevent hydraulic flow between wells.

In operation the method involves controlling the hydraulic flow through one or more fracture planes in a selected direction to or from the one or more primary boreholes by actuating one or more pumps in the well system and/or in one or more secondary boreholes.

According to a first example, the method involves controlling the hydraulic flow in at least one well to permit a hydraulic flow of fluid from the well and actuating a pump in at least one secondary borehole to pump fluid out of the secondary borehole to ground level in order to generate a hydraulic flow through at least one fracture plane from the selected well to the at least one of the secondary boreholes.

According to a second example, the method involves controlling the hydraulic flow in at least one secondary borehole to permit a hydraulic flow of fluid from the at least one of the secondary boreholes and actuating a pump in at least one well to pump fluid out of the well to ground level in order to generate a hydraulic flow through at least one fracture plane from the at least one of the secondary boreholes to the well.

In the above examples, the hydraulic flow can be controlled in a sector between a well and at least one secondary borehole and generating a hydraulic flow in a selected number of secondary boreholes towards or from a selected well depending on the flow direction. The size of the sector between the well and the secondary boreholes is determined by the number of secondary boreholes selected.

An advantage with a thermal energy storage as described above is that it allows any part of the storage volume, such as one or more fracture planes or one or more sectors, to be selectively charged or discharged. In this way, parts of the storage can be used for long term charging or discharging, while parts of the storage can be used for short term charging or discharging. Also, the flow rate required into or out of the thermal energy storage at any one time can be adapted to the current requirements for the production facility. This makes the thermal energy storage very flexible and allows for relatively quick adaptation of the storage volume or parts thereof. Stored energy can be used for heating indoor and outdoor spaces in the winter and/or cooling them in the summer. Suitable indoor environments can be offices, shopping centres, hospitals, greenhouses and housing in general. In addition, stored energy can be used for heating outdoor spaces and infrastructures such as roads, carparks, pavements, airport runways, etc.

### FIGURES

In the following text, the invention will be described in detail with reference to the attached drawings. These schematic drawings are used for illustration only and do not in any way limit the scope of the invention. In the drawings:

FIG. 1 shows a schematically indicated perspective view of a first example of a thermal energy storage;

FIG. 2 shows a schematically indicated perspective view of a second example of a thermal energy storage;

FIG. 3 shows a schematically indicated first example of a fluid source for a thermal energy storage;

FIG. 4 shows a schematically indicated second example of a fluid source for a thermal energy storage;

FIG. 5 shows a schematically indicated third example of a fluid source for a thermal energy storage;

FIG. 6 shows a schematically indicated fourth example of a fluid source for a thermal energy storage;

FIG. 7 shows a schematic illustration of temperature distribution in a rock body near a fracture plane in a storage volume;

FIG. 8 shows a thermal energy storage comprising a fluid source shown in FIG. 3;

FIG. 9 shows a perspective view of a thermal energy storage during charging of a sector; and

FIG. 10 shows a plan view of sectors in a fracture plane.

### DETAILED DESCRIPTION

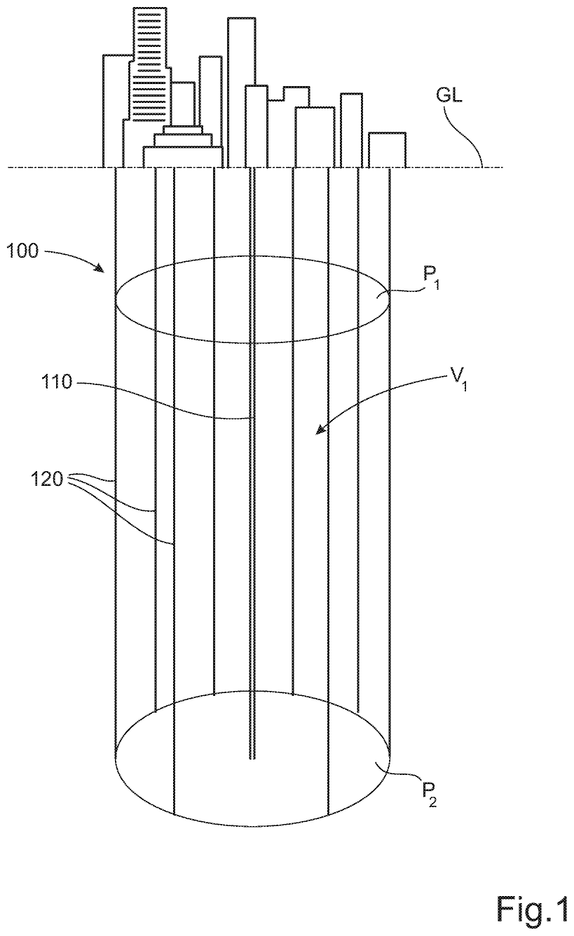

FIG. 1 shows a schematically indicated perspective view of a first example of a thermal energy storage 100 according to the invention. According to this example, the thermal energy storage 100 comprises one thermal energy storage volume V₁. The storage volume comprises a fluid source indicated in the form of a primary borehole 110 extending from ground level GL to a first predetermined depth in a rock body. A set of secondary boreholes 120 is located around the primary borehole 110 and extend from ground level GL to the same or to individual depths in the rock body. In this example, the primary borehole 110 extends downwards in a vertical direction relative to a horizontal plane at ground level to the bottom or base B of the storage volume V₁.

The fluid source can comprise a single primary borehole 110 or multiple primary boreholes (not shown). The at least one primary borehole 110 can have a greater diameter than the adjacent set of secondary boreholes 120, as multiple secondary boreholes are provided to supply a substantially central primary borehole. At least an upper fracture plane P₁ and a lower fracture plane P₂ extend in a radial and/or oblique plane from the primary borehole 110 towards adjacent secondary boreholes 120. A fluid, preferably water can flow between secondary boreholes 120 and a primary borehole 110 through the fracture planes P₁, P₂.

The set of secondary boreholes 120 is drilled substantially parallel to the primary borehole 110 at least between the upper and the lower fracture planes P₁, P₂ with increasing depth. The secondary boreholes 120 and the upper and lower fracture planes P₁, P₂ define a general outer boundary for a storage volume surrounding the at least one primary borehole 110. The storage volume indicated in FIG. 1 is schematically shown as an approximated, cylinder, wherein the secondary boreholes 120 form generatrices G along this approximated cylinder. However, the volume shown illustrates an ideal shape that is usually not possible to achieve. This and the subsequent figures do not necessarily represent a real thermal energy storage but are mainly intended to illustrate the principle of the invention applied to thermal energy storage solutions using simplified shapes such as a right or an oblique cylinder.

Each set of secondary boreholes comprises at least two drilled holes extending from ground level to a predetermined depth in the rock body and intersecting at least one fractured plane. Although a minimum of two drilled holes per set of secondary boreholes is possible within the scope of the invention, it is preferable to provide three or more secondary boreholes per set in order to create a more distinct storage volume about the at least one primary borehole. The non-limited example shown in FIG. 1 indicates at least eight secondary boreholes 120.

According to one example, the secondary boreholes are located spaced from the primary borehole at ground level, either around it in an equidistant or in a more or less evenly distributed pattern. According to a further example, a second set of secondary boreholes can be distributed in an approximately concentric pattern in-between the first and second set of secondary boreholes. Variations in numbers of secondary boreholes and/or their distribution about the central borehole can be caused by a number of factors, such as geological conditions or by an active selection of the borehole position to enable a secondary borehole to reach a particular fracture plane or to avoid obstacles, such as local infrastructure or an undesirable rock formation.

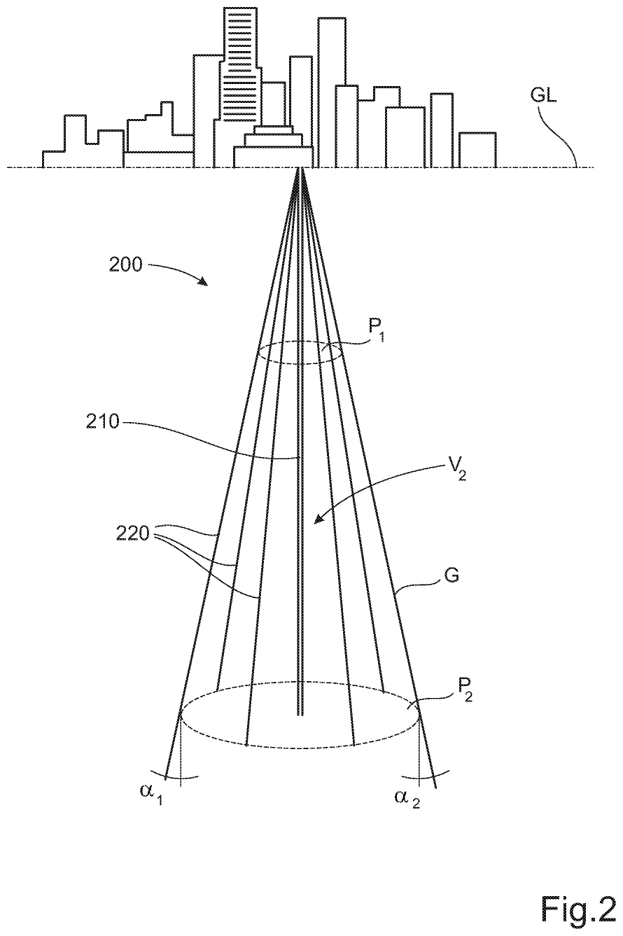

FIG. 2 shows a schematically indicated perspective view of a second example of a thermal energy storage 200 according to the invention.

According to this example, the thermal energy storage 200 comprises one thermal energy storage volume V₂. The storage volume comprises a fluid source indicated in the form of a primary borehole 210 extending from ground level GL to a first predetermined depth in a rock body. A set of secondary boreholes 220 is located around the primary borehole 210 and extend from ground level GL to the same or to individual depths in the rock body. In this example, the primary borehole 210 extends downwards in a vertical direction relative to a horizontal plane at ground level to the bottom or base B of the storage volume V₂.

The fluid source can comprise a single primary borehole 210 or multiple primary boreholes (not shown). The at least one primary borehole 210 can have a greater diameter than the adjacent set of secondary boreholes 220, as multiple secondary boreholes are provided to supply a substantially central primary borehole. At least an upper fracture plane P₁ and a lower fracture plane P₂ extend in a radial and/or oblique plane from the primary borehole 210 towards adjacent secondary boreholes 220. A fluid, preferably water can flow between secondary boreholes 220 and a primary borehole 210 through the fracture planes P₁, P₂.

The set of secondary boreholes 220 is drilled to diverge from the primary borehole 210 at least between the upper and the lower fracture planes P₁, P₂ with increasing depth. The secondary boreholes 220 and the upper and lower fracture planes P₁, P₂ define a general outer boundary for a storage volume surrounding the at least one primary borehole 210. The storage volume indicated in FIG. 2 is schematically shown as an approximated, truncated cone, wherein the secondary boreholes 220 form generatrices G along this approximated cone. However, the volume shown illustrates an ideal shape that is usually not possible to achieve. This and the subsequent figures do not necessarily represent a real thermal energy storage but are mainly intended to illustrate the principle of the invention applied to thermal energy storage solutions using simplified shapes such as a symmetrical, asymmetrical or skewed cone.

Each set of secondary boreholes comprises at least two drilled holes extending from ground level to a predetermined depth in the rock body and intersecting at least one fractured plane. Although a minimum of two drilled holes per set of secondary boreholes is possible within the scope of the invention, it is preferable to provide three or more secondary boreholes per set in order to create a more distinct storage volume about the at least one primary borehole. The non-limited example shown in FIG. 2 indicates at least six secondary boreholes 220.

According to one example, the secondary boreholes can be located adjacent the primary borehole at ground level, either around it in an equidistant or a more or less evenly distributed pattern. Alternatively, the secondary boreholes can be located in one or more clusters of two or more boreholes to at least one side of the primary borehole. Variations in numbers and/or the distribution about the central borehole can be caused by a number of factors, such as geological conditions or by an active selection of the borehole position to enable a secondary borehole to reach a particular fracture plane or to avoid obstacles, such as local infrastructure or an undesirable rock formation.

Individual secondary boreholes 220 within a set can be drilled at a desired angle relative to the at least one primary borehole, but this angle is likely to vary from hole to hole as indicated by the drilling angles α₁ and α₂ in FIG. 2. The desired angle is selected together with the relative locations of the upper and lower fracture planes P₁, P₂ to achieve a storage volume for a thermal energy storage having a desired size and heat storage capacity. In the case of a vertical primary borehole, a secondary borehole can diverge away from the primary borehole at angles up to 45° from the vertical direction at each fractured plane level. Variations in the drilling angle can be caused by a number of factors, such as geological conditions, obstacles in the form of infrastructure, or by an active selection to enable a secondary borehole to reach a particular fracture plane. In FIG. 2, the secondary boreholes 220 are arranged to reach ground level GL without intersecting the primary borehole 210. In the first example this is achieved by locating the apex of an imaginary approximated cone defined by the secondary boreholes 220 above ground level GL.

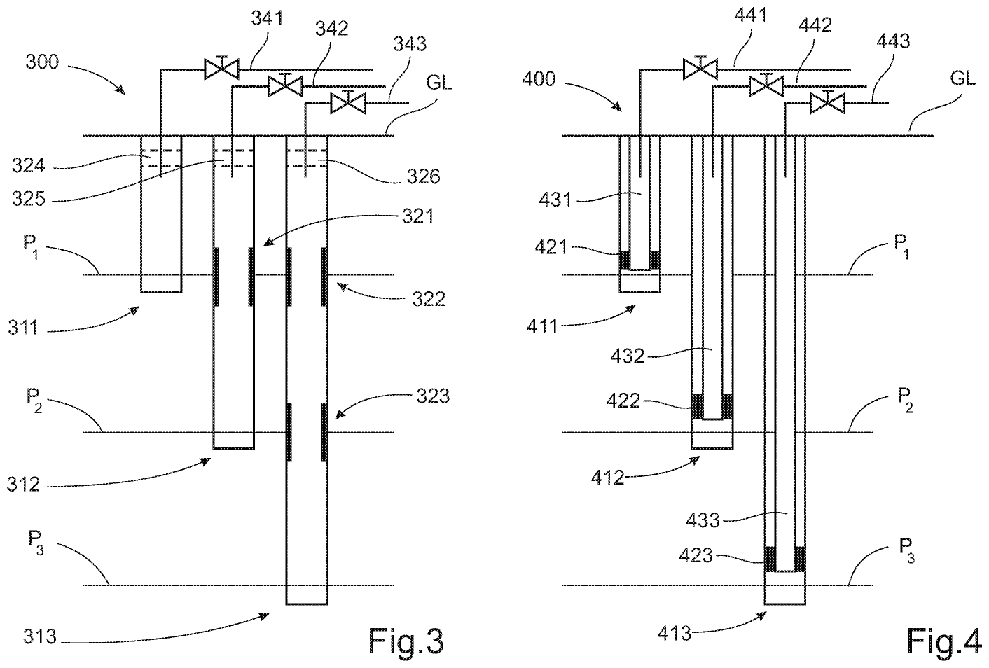

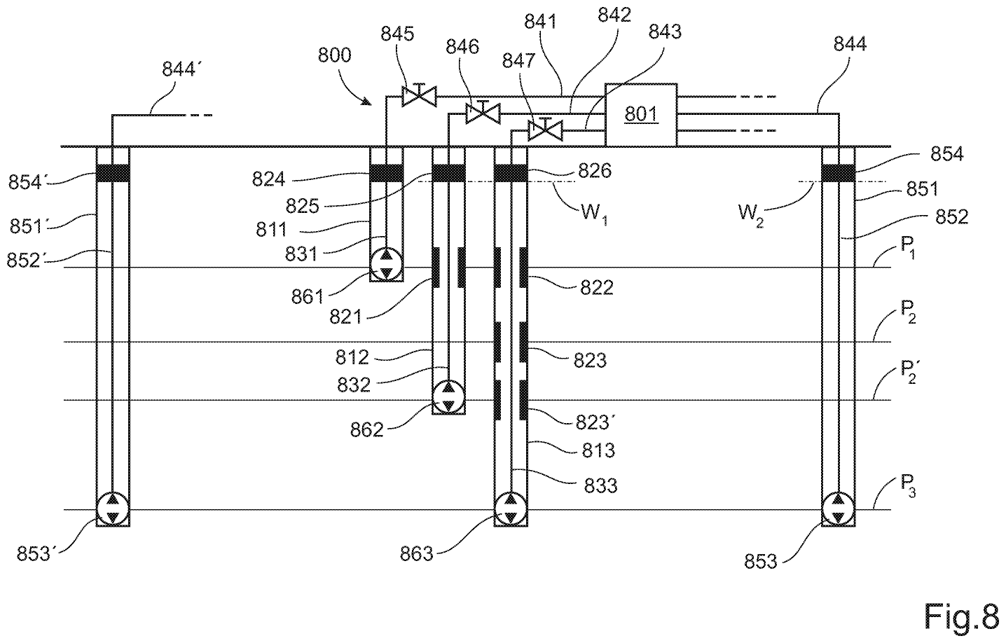

FIG. 3 shows a schematically indicated first example of a fluid source 300 suitable for a thermal energy storage as shown in FIG. 1 or 2. According to this first example, the fluid source 300 comprises a well system where each well is an individual primary borehole 311, 312, 313 extending from ground level GL past one or more intermediate fracture planes P₁, P₂, P₃. Each well 311, 312, 313 is separated from each intermediate fracture plane P₁, P₂, P₃ by an annular sealing element 321, 322, 323 located level with each intermediate fracture plane P₁, P₂, P₃. In this way, each primary borehole 311, 312, 313 forms a well that is in fluid connection with a fracture plane P₁, P₂, P₃ or a group of adjacent fracture planes (see FIG. 8). In order to prevent flow from a primary borehole into a fracture plane not associated with said primary borehole, an annular sealing element comprising, for instance, concrete is placed around the inner perimeter of the primary borehole level with the fracture plane intersecting the primary borehole. The example in FIG. 3 shows three fracture planes P₁, P₂, P₃, wherein a first primary borehole 311 extends down to and is arranged to supply water to or withdraw water from a first fracture plane P₁. A second primary borehole 312 extends past the first fracture plane P₁ down to a second fracture plane P₂, wherein fluid communication with the first fracture plane P₁ is prevented by a first annular sealing element 321. Finally, a third primary borehole 313 extends past the first and second fracture planes P₁, P₂ down to a third fracture plane P₃, wherein fluid communication with the first fracture plane P₁ is prevented by a second annular sealing element 322. Fluid communication with the second fracture plane P₂ is prevented by a third annular sealing element 323. Consequently, fluid communication between a primary borehole and any intermediate fracture planes can be prevented. Separate primary boreholes, each forming individual a well at different depths, are provided for each fracture plane or group of adjacent fracture planes throughout the storage volume.

Each primary borehole 311, 312, 313 can be provided with an optional upper sealing element 324, 325, 326 located between ground level GL and the first fracture plane P₁. The optional upper sealing elements 324, 325, 326 are located a suitable distance below the groundwater table to prevent surface water and groundwater from entering the primary boreholes 311, 312, 313. The primary boreholes will be completely filled with water up to the upper sealing elements 324, 325, 326, as the presence of air in the water column is undesirable. Above the upper sealing elements 324, 325, 326 the primary boreholes can be filled with groundwater. The optional upper sealing elements 324, 325, 326 also make it possible to supply water at a positive pressure during charging of the fracture plane or planes associated with each primary borehole. Similarly, a negative pressure can be applied during discharging of the fracture plane or planes P₁, P₂, P₃. Each primary borehole 311, 312, 313 is connected to a conduit 341, 342, 343 above ground level GL for the purpose of supplying or withdrawing water.

FIG. 4 shows a schematically indicated second example of a fluid source 400 suitable for a thermal energy storage as shown in FIG. 1 or 2. According to the second example, the fluid source 400 comprises a well system where each well is arranged in a primary borehole 411, 412, 413 extending from ground level GL past one or more intermediate fracture planes P₁, P₂, P₃. Each well comprises a pipe 431, 432, 433 extending to and/or past one or more intermediate fracture planes P₁, P₂, P₃ to its respective fracture plane, or group of fracture planes. Each well 431, 432, 433 is separated from each intermediate fracture plane P₁, P₂, P₃ by a sealing element 421, 422, 423 arranged below the lowermost intermediate fracture plane. In this way, each primary borehole comprises a well that is in fluid connection with a fracture plane or a group of adjacent fracture planes. In order to prevent flow from the well into a fracture plane not associated with said primary borehole, an annular sealing element is placed in the gap between the inner perimeter of the primary borehole and the outer surface of the pipe.

The example in FIG. 4 shows three fracture planes P₁, P₂, P₃, wherein a first primary borehole 411 comprising a first pipe 431 extends down to and is arranged to supply water to or withdraw water from a first fracture plane P₁. A first annular sealing element 421 is placed around the first pipe 431 above the first fracture plane P₁ to prevent ingress of groundwater. A second primary borehole 412 comprising a second pipe 432 extends past the first fracture plane P₁ down to a second fracture plane P₂, wherein fluid communication with the first fracture plane P₁ is prevented by a second annular sealing element 422. The second annular sealing element 422 is placed around the second pipe 432 between the first and second fracture planes P₁, P₂. Finally, a third primary borehole 413 comprising a third pipe 433 extends past the first and second fracture planes P₁, P₂ down to a third fracture plane P₃, wherein fluid communication with the first fracture plane P₁ is prevented by a second annular sealing element 422. Further, fluid communication with the second fracture plane P₂ is prevented by a third annular sealing element 423. The first annular sealing element 421 is positioned above the first fracture plane P₁. The second annular sealing element 422 is positioned above the second fracture plane P₂ and below the intermediate first fracture plane P₁. The third annular sealing element 423 is positioned above the third fracture plane P₃ and below the intermediate first and second fracture planes P₁, P₂. Consequently, fluid communication between the well and any intermediate fracture planes can be prevented. Additional annular sealing elements (not shown) can be placed around the second and third pipes 432, 433 above the first fracture plane P₁ to prevent ingress of groundwater. Separate primary boreholes, each with a pipe forming an individual well at different depths, are provided for each fracture plane or group of adjacent fracture planes throughout the storage volume. Water is supplied or withdrawn using individual conduits 441, 442, 443 extending into a respective pipe 431, 432, 433 from ground level GL.

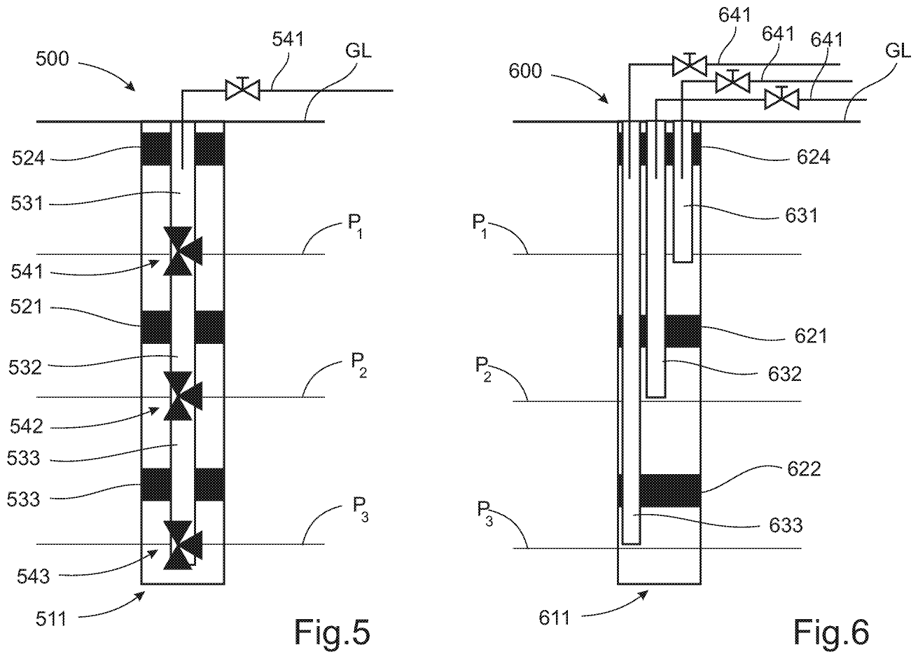

FIG. 5 shows a schematically indicated third example of a fluid source 500 suitable for a thermal energy storage as shown in FIG. 1 or 2. According to the third example, the fluid source comprises a primary borehole 511 with a well system in the form of a pipe 531, 532, 533 having sections that extend down to the fracture planes P₁, P₂, P₃. The pipe 531, 532, 533 comprises a controllable valve 541, 542, 543 for each pipe section, where each valve is operable to form an individual well in fluid communication with its respective fracture plane P₁, P₂, P₃. Each well is separated from other wells in the primary borehole by at least one sealing element 521, 522 arranged in a gap between the pipe 531, 532, 533 and inner perimeter of the primary borehole 511. In this way, a single pipe 531, 532, 533 can form multiple wells, where each well is in fluid connection with a fracture plane or a group of adjacent fracture planes.

The example in FIG. 5 shows three fracture planes P₁, P₂, P₃, wherein a first primary borehole 511 extends from ground level down to the bottom of the thermal storage volume. A first pipe section 531 extends from ground level GL down to a first fracture plane P₁ and is arranged to supply water to or withdraw water from this first fracture plane P₁. A first controllable valve 541 is provided at the lower end of the first pipe section 531 level with the first fracture plane P₁. The first valve 541 is controllable between a first position where fluid can be supplied to or withdrawn from the first fracture plane P₁, while closing the flow of fluid to subsequent pipe sections, and a second position where fluid can be supplied to or withdrawn from subsequent pipe sections 532, 533, while closing the flow of fluid to the first fracture plane P₁. When the first valve 541 is in its first position, fluid communication between the first and the second fracture planes P₁, P₂ is prevented by a first annular sealing element 521 located between the first fracture plane P₁ and a second fracture plane P₂. A second pipe section 532 extends downwards from the first controllable valve 541 past the first fracture plane P₁, through the first sealing element 521 and down to the second fracture plane P₂. The first pipe section 531 can be provided with an optional upper sealing element 524 located between ground level GL and the first fracture plane P₁. The optional upper sealing element 524 are located a suitable distance below the groundwater table to prevent surface water and groundwater from entering the upper portion of the primary borehole 511 surrounding the first pipe section 531. The optional upper sealing element 524 also makes it possible to supply water at a positive pressure during charging of the first fracture plane P₁. Similarly, a negative pressure can be applied during discharging of the first fracture plane P₁.

A second controllable valve 542 is provided at the lower end of the second pipe section 532 level with the second fracture plane P₂. The second valve 542 is controllable between a first position where fluid can be supplied to or withdrawn from the second fracture plane P₂, while closing the flow of fluid to subsequent pipe sections, and a second position where fluid can be supplied to or withdrawn from a subsequent pipe section 533, while closing the flow of fluid to the second fracture plane P₂. When the second valve 542 is in its first position, fluid communication between the first and the second fracture planes P₁, P₂ is prevented by the first annular sealing element 521 between the first and second fracture planes P₁, P₂ as described above. In addition, fluid communication between the second fracture plane P₂ and a third fracture plane P₃ is prevented by a second annular sealing element 522 located between the second and third fracture planes P₂, P₃. Finally, a third pipe section 533 extends downwards from the second controllable valve 542 past the second fracture plane P₂, through the second sealing element 522 and down to the third fracture plane P₃.

A third controllable valve 543 is provided at the lower end of the third pipe section 533 level with the third fracture plane P₃. The third valve 543 is controllable between a first position where fluid can be supplied to or withdrawn from the third fracture plane P₃, and a second position where the valve is closed and a flow of fluid through the pipe 531, 532, 533 to the third fracture plane P₃ Is prevented. When the third valve 543 is in its first position, fluid communication with the second fracture plane P₂ is prevented by the second annular sealing element 522.

In operation, when a valve along the pipe 531, 532, 533 is opened, the pipe section or sections extending from ground level down to the opened valve forms a well to a fracture plane associated with that valve. The valves are controllable individually to supply a single fracture plane or group of adjacent fracture planes, or together to supply several single fracture planes or groups of adjacent fracture planes. In order to prevent flow from the well into a fracture plane not associated with said well, annular sealing elements are placed in the gap between the inner perimeter of the primary borehole and the outer surface of the pipe. Each annular sealing element is positioned above each controllable valve, above the fracture plane or group of adjacent fracture planes associated with said valve, and below the nearest intermediate fracture plane above the valve. Consequently, fluid communication between the valve forming a well and adjacent fracture planes can be prevented. This makes it possible to supply water at a positive pressure during charging of the fracture plane or planes associated with each valve. Similarly, a negative pressure can be applied during discharging of the fracture plane or planes associated with each valve. Water is supplied or withdrawn using a conduit 541 extending into the pipe 531, 532, 533 from ground level GL.

According to a further alternative, a primary borehole can comprise more than one pipe as shown in FIG. 6. Each pipe can be provided with one or more valves forming individual wells at different depths, in order to supply each fracture plane or group of adjacent fracture planes throughout the storage volume.

FIG. 6 shows a schematically indicated fourth example of a fluid source 600 suitable for a thermal energy storage as shown in FIG. 1 or 2. According to the fourth example, the fluid source comprises a primary borehole 611 with a well system in the form of individual pipes 631, 632, 633 extending down to a respective fracture plane P₁, P₂, P₃. Each pipe 631, 632, 633 forms a well that is separated from other wells in the primary borehole 611 sealing element 621, 622 arranged between the inner perimeter of the primary borehole and the outer surface of one or more pipes 631, 632, 633. In this way, every well comprises a single pipe 631, 632, 633, where each well is in fluid connection with a fracture plane P₁, P₂, P₃. In order to prevent flow from the well into a fracture plane not associated with said well, an annular sealing element is positioned above the fracture plane or group of adjacent fracture planes associated with said well and below the nearest intermediate fracture planes above the well.

The example in FIG. 6 shows three fracture planes P₁, P₂, P₃, wherein a first primary borehole 611 extends from ground level GL down to the bottom of the thermal storage volume. A first pipe 631 extends from ground level GL down to a first fracture plane P₁ and is arranged to supply water to or withdraw water from this first fracture plane P₁. Fluid communication between the first and the second fracture planes P₁, P₂ is prevented by a first annular sealing element 621 located between the first fracture plane P₁ and a second fracture plane P₂. A second pipe 632 extends from ground level GL down to the second fracture plane P₂ and is arranged to supply water to or withdraw water from this second fracture plane P₂. Fluid communication between the first and the second fracture planes P₁, P₂ is prevented by a first annular sealing element 621 located between the first fracture plane P₁ and a second fracture plane P₂. The first sealing element 621 is arranged in a gap between the second pipe 632 and inner perimeter of the primary borehole 611. In addition, fluid communication between the second fracture plane P₂ and a third fracture plane P₃ is prevented by a second annular sealing element 622 located between the second and third fracture planes P₂, P₃. A third pipe 633 extends from ground level GL and through the first sealing element 621 down to the third fracture plane P₃, where it is arranged to supply water to or withdraw water from this third fracture plane P₃. Fluid communication between the second and the third fracture planes P₂, P₃ is prevented by the second annular sealing element 622 located between the second fracture plane P₂ and the third fracture plane P₃. The second annular sealing element 622 is arranged in a gap between the third pipe 633 and inner perimeter of the primary borehole 611.

Each pipe 631, 632, 633 can be provided with an optional upper sealing element 624 located between ground level GL and the first fracture plane P1. The optional upper sealing element 624 are located a suitable distance below the groundwater table to prevent surface water and groundwater from entering the upper portion of the primary borehole 611 surrounding the first pipe 631. The optional upper sealing element 624 also make it possible to supply water at a positive pressure during charging of the first fracture plane P₁. Similarly, a negative pressure can be applied during discharging of the first fracture plane P₁. Each pipe 631, 632, 633 is connected to a conduit 641, 642, 643 above ground level GL for the purpose of supplying or withdrawing water.

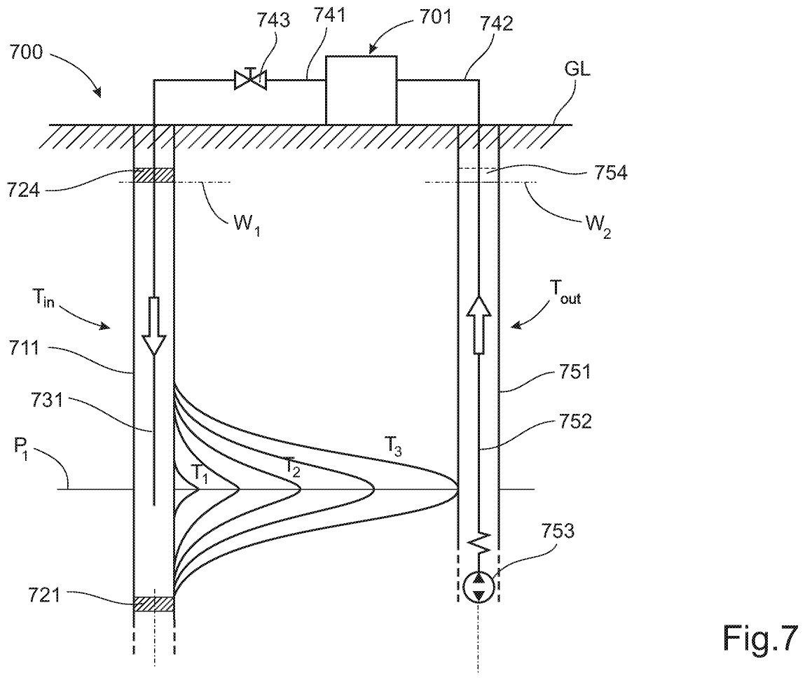

FIGS. 3-6 show different examples of fluid sources for a thermal storage according to the invention. As shown in these figures, a fluid source can comprise a well system where each well is an individual primary borehole or a primary borehole with a well system in the form of one or more pipes. A combination of such well systems is of course also possible. The examples shown in FIGS. 3-6 do not indicate that pumps can be used for assisting the flow of water in a selected direction during charging or discharging of a thermal storage volume or a portion thereof. However, in order to assist the flow of water out of a primary borehole or a well in a primary borehole during discharging, it is possible to provide a suitable submersible pump at the bottom of the primary borehole or at the end of a well located in a primary borehole. Such submersible pumps are located at or preferably below the level of an adjacent fracture plane. Similarly, a submersible pump can be located at the bottom of each secondary borehole to assist the flow of water out of one or more secondary boreholes during charging. Examples of pump arrangements will be described in connection with FIGS. 7-9 below.

FIG. 7 shows a schematic illustration of temperature distribution in a rock body in the vicinity of a fracture plane in a storage volume during a charging process. In operation, a fluid source 700 in the storage volume is supplied with heated water from a supply facility 701 at ground level GL. Heated water is arranged to flow through a supply conduit 741 when a controllable valve 743 is opened. The water is supplied from the supply conduit 741 to the fluid source 700 comprising a primary borehole 711 and a first pipe 731 extending from ground level GL down to a first fracture plane P₁. For reasons of clarity, only one pipe 731 is shown in FIG. 7. Also, additional pipes (indicated in dashed lines) extending past the first fracture plane P₁ to lower fracture planes can also be provided. The heated water can be supplied under pressure to increase the flow rate into the first fracture plane P₁, in which case a first sealing element 721 is arranged below the first fracture plane P₁ and above a subsequent fracture plane (not shown). A further, upper sealing element 724 is provided in a gap between the first pipe 731 and the inner periphery of the primary borehole 711 in the upper portion of the primary borehole 711, preferably below the groundwater table.

Heated water at a first temperature Tᵢₙ is injected into the primary borehole 711 through the first pipe 731 into the space between the sealing elements 721, 724. The water will then filter into and through the first fracture plane P₁ towards a secondary borehole 751. During this process, the water level W₁ in the primary borehole 711 is at the level of the upper sealing element 724. The space above the primary upper sealing element 724 will be filled by surface water and groundwater. The flow rate through the first fracture plane P₁ can be assisted by actuating a submersible pump 753 located in the secondary borehole 751. In FIG. 7 the schematically indicated pumps are located at an adjacent fracture plane, but a preferred location is below the level of the fracture plane.

In this way, relatively colder water at a second temperature Tₒᵤₜ can be pumped out of the secondary borehole 751 through a secondary pipe 752, whereby the pressure in the secondary borehole 751 will drop and assist the flow towards the secondary borehole 751.

The flow rate through the first fracture plane P₁ can be increased further by arranging an optional secondary upper sealing element 754 in a gap between the secondary pipe 752 and the inner periphery of the secondary borehole 751 in the upper portion of the secondary borehole 751, preferably below the groundwater table. This allows a negative pressure to be applied within the secondary borehole 751 in order to further assist the flow rate. The cold water is pumped from the secondary pipe 752 to the supply facility 701 via a return conduit 742. During this process, the water level W₂ in the secondary borehole 751 is at the level of the secondary upper sealing element 754, as the presence of air in the water column will have a detrimental effect on the pumping process. The space above the secondary upper sealing element 754 will be filled by groundwater.

During the charging process, heated water can be supplied to the first fracture plane P₁ at a first, or inlet temperature Tᵢₙ in the range 20-100° C., depending on the source of the heated water. At the start of the charging process, the temperature of the rock surrounding the first fracture plane P₁ can be in the range 4-5° C. The flow rate into the first fracture plane P₁ is controlled to create an even temperature gradient throughout the fracture plane. FIG. 7 shows an example of a desired temperature gradient at the end of a charging process, wherein the temperature gradient curves T₁, T₂, T₃ gradually decrease with the distance from the primary borehole 711. A temperature sensor (not shown) can be provided, for instance, in one or more locations in the secondary borehole 751 or in the supply facility 701. When a sensor indicates that the second, or outlet temperature Tₒᵤₜ of the water being pumped out of the secondary borehole 751 has reached a predetermined temperature, then the charging process is completed. The predetermined temperature is selected above the ambient rock temperature. For instance, if the ambient rock temperature is about 4-5° C. then the predetermined outlet temperature Tₒᵤₜ can be selected at 10° C.

During a subsequent discharging process, the above steps are reversed. Water at a temperature above the ambient rock temperature is withdrawn from the primary, or production borehole 711, while relatively colder water is pumped into the secondary borehole 751. In order to control the flow rate out of the primary borehole 711, a submersible pump (not shown) can be provided at the lower end of the first pipe 731.

FIG. 8 shows a thermal energy storage comprising a fluid source 800 of the type shown in FIG. 3. According to this example, the fluid source 800 comprises a well system where each well is an individual primary borehole 811, 812, 813 extending from ground level GL past one or more intermediate fracture planes P₁, P₂, P₂′, P₃. Each well 811, 812, 813 is separated from each intermediate fracture plane or group of fracture planes P₁, P₂, P₂′, P₃ by an annular sealing element 821, 822, 823, 823′ located level with each intermediate fracture plane P₁, P₂, P₂′, P₃. In this way, each primary borehole 811, 812, 813 forms a well that is in fluid connection with a fracture plane or group of adjacent fracture planes P₁, P₂, P₂′, P₃. In order to prevent flow from a primary borehole into a fracture plane not associated with said primary borehole, an annular sealing element comprising, for instance, concrete is placed around the inner perimeter of the primary borehole level with the fracture plane intersecting the primary borehole. The example in FIG. 8 shows four fracture planes P₁, P₂, P₂′, P₃, wherein a first primary borehole 811 extends down to and is arranged to supply water to or withdraw water from a first fracture plane P₁. A second primary borehole 812 extends past the first fracture plane P₁ down to a group of second fracture planes P₂, P₂′ wherein fluid communication with the first fracture plane P₁ is prevented by a first annular sealing element 821 located level with the first fracture plane P₁. Finally, a third primary borehole 813 extends past the first fracture plane P₁ and the group of second fracture planes P₂, P₂′ down to a third fracture plane P₃, wherein fluid communication with the first fracture plane P₁ is prevented by a second annular sealing element 822 level with the first fracture plane P₁. Fluid communication with the group of second fracture planes P₂. P₂′ is prevented by a pair of third annular sealing elements 823, 823′ level with the upper second fracture plane P₂ and the lower second fracture plane P₂′, respectively. Consequently, fluid communication between a primary borehole and any intermediate fracture planes can be prevented.

Each primary borehole 811, 812, 813 is provided with an upper sealing element 824, 825, 826 located between ground level GL and the first fracture plane P₁. The upper sealing elements 824, 825, 826 are located a suitable distance below the groundwater table to prevent surface water and groundwater from entering the primary boreholes 811, 812, 813. The upper sealing elements 824, 825, 826 also make it possible to supply water at a positive pressure during charging of the fracture plane or planes associated with each primary borehole. Similarly, a negative pressure can be applied during discharging of the fracture plane or planes P₁, P₂, P₂′, P₃. Each primary borehole 811, 812, 813 is connected to a conduit 841, 842, 843 above ground level GL for the purpose of supplying or withdrawing water.

In operation, the fluid source 800 is supplied with heated water from a supply facility 801 at ground level GL. Heated water is arranged to flow through supply conduits 841, 842, 843 when a controllable valve 845, 846, 847 associated with respective supply conduit is opened. Each of the supply conduits 841, 842, 843 is connected to a pipe 831, 832, 833 extending from ground level GL to the bottom of a respective primary borehole 811, 812, 813. The end of each pipe 831, 832, 833 is in turn connected to a submersible reversible pump 861, 862, 863. In FIG. 8 the schematically indicated pumps are located at an adjacent fracture plane, but a preferred location is below the level of the fracture plane. In this way it is possible to selected which fracture layer or group of layers to charge. For example, heated water can be supplied from the supply facility 801 to a second supply conduit 842 and a second pipe 832 extending into the second primary borehole 812 from ground level GL down to a group of second fracture planes P₂, P₂′. The heated water can be supplied under pressure to increase the flow rate into the second fracture planes P₂, P₂′, which pressure can be controlled by operation of a second valve 846 in the second supply conduit 842 and/or by actuation of the second pump 862 in the second primary borehole 812. The pressure can be maintained by means of the first annular sealing element 821 described above, and by a second upper sealing element 825 is provided in a gap between the second pipe 832 and the inner periphery of the second primary borehole 812. The second upper sealing element 825 is located in an upper portion of the primary borehole 812, preferably below the groundwater table.

Heated water at a first temperature Tᵢₙ is injected into the second primary borehole 812 through the second pipe 832 into a space where the group of second fracture planes P₂, P₂′ intersect the second primary borehole 812. The water will then filter into and through the group of second fracture planes P₂, P₂′ towards one or more secondary boreholes 852, 852′. During this process, the water level W₁ in the second primary borehole 812 is at the level of the second upper sealing element 825. The flow rate through the group of second fracture planes P₂, P₂′ can be assisted by actuating a submersible pump 853 located in the secondary borehole 851. In this way, relatively colder water at a second temperature Tₒᵤₜ can be pumped out of the secondary borehole 851 through a secondary pipe 852 connected to the secondary pump 853, whereby the pressure in the secondary borehole 851 will drop and assist the flow towards the secondary borehole 851. The flow rate through the group of second fracture planes P₂, P₂′ can be increased further by a secondary upper sealing element 854 arranged in a gap between the second pipe 853 and the inner periphery of the secondary borehole 851. The secondary upper sealing element 854 is located in the upper portion of the secondary borehole 851, preferably below the groundwater table. This allows a negative pressure to be applied within the secondary borehole 851 in order to further assist the flow rate. The cold water is pumped from the second pipe 852 to the supply facility 801 via a return conduit 844. During this process, the water level W₂ in the secondary borehole 851 is at the level of the secondary upper sealing element 854, as the presence of air in the water column will have a detrimental effect on the pumping process.

The above example only describes the flow between a primary borehole and one secondary borehole during charging. However, by individual control of one, multiple or all pumps located in the secondary boreholes around the primary borehole, as indicated by the secondary boreholes 851 and 851′ in FIG. 8, it is possible to charge anything from a single sector of a fracture plane to an entire fracture plane connected to a primary borehole or a well. The process is applicable for charging a single or multiple fracture planes, using a single or multiple primary boreholes or wells.

During the charging process, heated water can be supplied to the group of second fracture planes P₂, P₂′ at a first, or inlet temperature Tᵢₙ in the range 20-100° C., depending on the source of the heated water. At the start of the charging process, the temperature of the rock surrounding each of the second fracture planes P₂, P₂′ can be in the range 4-5° C. The flow rate into the group of second fracture planes P₂, P₂′ is controlled to create an even temperature gradient throughout the fracture plane. FIG. 7 shows an example of a desired temperature gradient at the end of a charging process, wherein the temperature gradient curves T₁, T₂, T₃ gradually decrease with the distance from the primary borehole 811. A temperature sensor (not shown) can be provided in, for instance, the secondary borehole 851 or in the supply facility 801. When the second, or outlet temperature Tₒᵤₜ of the water being pumped out of the secondary borehole 851 reaches a predetermined temperature, then the charging process is completed. The predetermined temperature is selected above the ambient rock temperature. For instance, if the ambient rock temperature is about 4-5° C. then the predetermined outlet temperature Tₒᵤₜ can be selected at 10° C.

During a subsequent discharging process, the above steps are reversed. When discharging the group of second fracture planes P₂, P₂′ described above, water at a temperature above the ambient rock temperature is withdrawn from the second primary borehole 812, while relatively colder water is pumped from the supply facility 801 into one or more secondary boreholes 851, 851′. In order to control the flow rate out of the second primary borehole 812, the submersible pump 862 at the bottom of the primary borehole can be actuated. Water is then pumped up through the second pipe 832 towards the supply facility 801, where heat can be recuperated by means of a heat pump or similar.

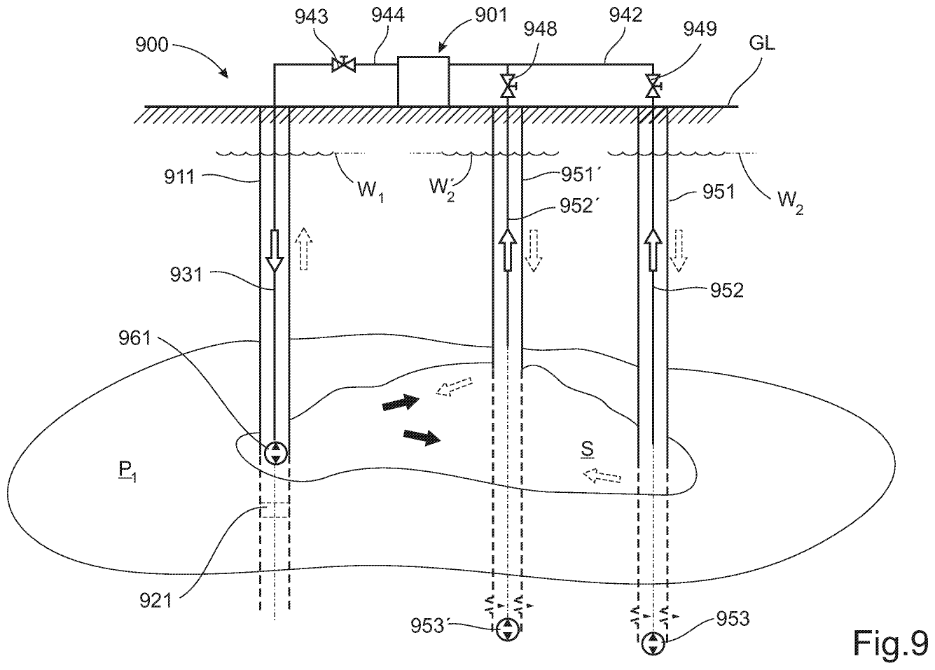

FIG. 9 shows a perspective view of a thermal energy storage during charging of a sector of a fracture plane. In this example, the storage volume comprises a fluid source 900 that is supplied with heated water from a supply facility 901 at ground level GL. Heated water is arranged to flow through a supply conduit 944 when a controllable valve 943 is opened. The water is supplied from the supply conduit 944 to the fluid source 900 comprising a primary borehole 911 and a first pipe 931 extending from ground level GL down to a first fracture plane P₁. For reasons of clarity, only one pipe 931 is shown in FIG. 9. The heated water can be supplied under pressure to increase the flow rate into the first fracture plane P₁, in which case a first sealing element 921 is arranged below the first fracture plane P₁ and above a subsequent fracture plane (not shown). A further, upper sealing element can be provided in a gap between the first pipe 931 and the inner periphery of the primary borehole 911 in the upper portion of the primary borehole 911, preferably below the groundwater table.

Heated water at a first temperature is injected into the primary borehole 911 through the first pipe 931 towards the first fracture plane P₁ as indicated by arrows in FIG. 9. The water will then filter into and through a sector S of the first fracture plane P₁ towards a pair of selected secondary boreholes 951, 951′. The well system could comprise a single pipe with valves as shown in FIG. 5 or multiple pipes as shown in FIG. 6. For reasons of clarity, only one pipe 931 is shown in FIG. 9. During this process, the water level W₁ in the primary borehole 911 can be relatively near ground level, but below the water table. Surface water or groundwater water is prevented from entering the upper end of the primary borehole 911 by a lining extending from ground level into the borehole and at least past the level of the water table. Alternatively, an upper sealing element can be provided around the pipe 931 below the level of the water table, in which case the water level in the borehole is at the sealing element to exclude air from the water column below the sealing element. The direction and flow rate through the sector S of the first fracture plane P₁ is ensured by actuating submersible pumps 953, 953′ located in the secondary boreholes 951, 951′. In FIG. 9 the schematically indicated pumps are located at an adjacent fracture plane, but a preferred location is below the level of the fracture plane. In this way, relatively colder water at a second temperature can be pumped out of the secondary boreholes 951, 951′ through secondary pipes 952 and 952′, respectively, whereby the water level W₂ in the secondary boreholes 951, 951′ will drop and reduce the water column relative to the primary borehole 911. As the pumps in the remaining secondary boreholes are not actuated, no flow will occur through the first fracture plane in the direction of these boreholes.

The flow rate through the sector S of the first fracture plane P₁ can be increased further by arranging an optional secondary upper sealing element (see FIG. 8) in a gap between the secondary pipes and the inner periphery of the secondary boreholes in the upper portion of the secondary boreholes, preferably below the groundwater table. This allows a negative pressure to be applied within the secondary boreholes in order to further assist the flow rate. The cold water is pumped from the secondary pipes 952, 952′ to the supply facility 901 via a common return conduit 942. During this process, the water level W₂ in the secondary boreholes can initially be at or near the level of the secondary upper sealing elements.

During the charging process, heated water can be supplied to the sector S of the first fracture plane P₁ at a first, or inlet temperature Tᵢₙ in the range 20-100° C., depending on the source of the heated water. At the start of the charging process, the temperature of the rock surrounding the first fracture plane P₁ can be in the range 4-5° C. The flow rate into the first fracture plane P₁ is controlled to create an even temperature gradient throughout the fracture plane. FIG. 7 shows an example of a desired temperature gradient at the end of a charging process. A temperature sensor (not shown) can be provided, for instance, in the secondary boreholes 951, 951′ or in the supply facility 901. When the second, or outlet temperature Tₒᵤₜ of the water being pumped out of the secondary boreholes 951, 951′ reaches a predetermined temperature, then the charging process is completed. The predetermined temperature is selected above the ambient rock temperature. For instance, if the ambient rock temperature is about 4-5° C. then the predetermined outlet temperature Tₒᵤₜ can be selected at 10° C.

During a subsequent discharging process of the sector S, the above steps are reversed. Water at a temperature above the ambient rock temperature is withdrawn from the primary, or production borehole 911. In order to control the flow rate out of the primary borehole 911, a submersible pump 961 can be provided at the lower end of the first pipe 931 level with the first fracture plane P₁. At the same time, relatively colder water is supplied to the secondary boreholes 951, 951′. By controlling a pair of valves 948, 949 at the upper ends of the secondary pipes 952, 952′ it is possible to supply water to the secondary boreholes 951, 951′ associated with the selected sector S of the first fracture plane P₁. This limits the flow of water to the selected sector S of the first fracture plane P₁. As no water is supplied to the remaining secondary boreholes, no flow will occur through the first fracture plane from these boreholes. The reverse flow directions are indicated by arrows in dashed lines in FIG. 9.

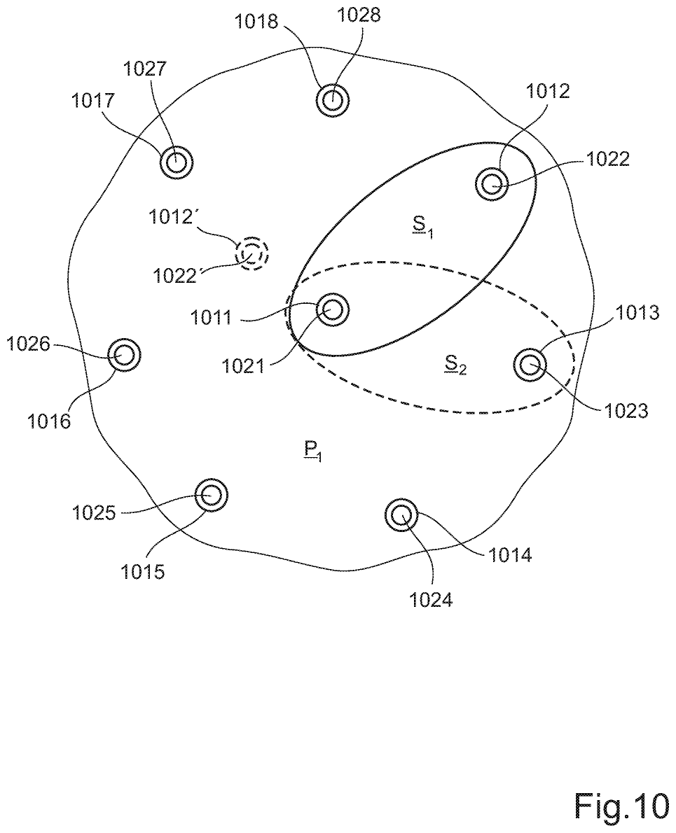

FIG. 10 shows a plan view of sectors in a fracture plane. A first fracture plane P₁ Intersects a primary borehole 1011 containing at least one first pipe 1021 (one shown) extending at least down to the first fracture plane P1. The primary borehole 1011 is intended as a schematic illustration of a fluid source with a well system as shown in FIG. 5 or 6 above. Alternatively, the first fracture plane P₁ Intersects multiple primary boreholes 1011, 1011′ each forming a well, or containing a first pipe 1021 forming a well, which well extends at least down to the first fracture plane P₁. The primary boreholes 1011, 1011′ are intended as a schematic illustration of a fluid source with a well system as shown in FIG. 3 or 4 above. Combinations of the examples illustrating different well systems in FIGS. 3-6 are of course also possible.

The primary boreholes 1011, 1011′ or the first pipes 1021, 1021′ are arranged to supply or withdraw water from at least the first fracture plane P₁ during charging and discharging, respectively. The at least one primary borehole 1011 is surrounded by multiple secondary boreholes 1012, 1013, 1014, 1015, 1016, 1017, 1018, each containing a secondary pipe 1022, 1023, 1024, 1025, 1026, 1027, 1028 extending to the bottom of its respective secondary borehole.

During charging and discharging it is possible to control to flow direction and flow rate through the entire first fracture plane P₁ by controlling submersible pumps located at the bottom of every secondary borehole 1012, 1013, 1014, 1015, 1016, 1017, 1018. The pumps can be located level with an adjacent fracture plane, but a preferred location is below the level of the fracture plane. Alternatively, it is possible to control to flow direction and flow rate through a sector S₁ of the first fracture plane P₁ by controlling submersible pumps located at the bottom of a single secondary borehole 1012. The flow through an additional second sector S₂ can be controlled by controlling a pump in a secondary borehole 1013 associated with that sector S₂.

The object of the invention is to provide a thermal energy storage in rock without the restrictions which characterise existing systems. More specifically, it is an object to bring about a large contact area between the heat carrier, such as heated/cooled water or another fluid, and the rock used as a thermal accumulator. According to the invention a characteristic of many superficial bedrocks is utilized, namely that the vertical direction, with the exception of very local deviations, coincides with the least principle stress. During hydraulic fracturing, the rock is fractured in substantially parallel fracture planes, which planes extend in predominantly or approximately in horizontal directions. The expression “predominantly or approximately in horizontal directions” should be understood to mean that the general direction over a large area is mainly horizontal, but that moderate inclinations can occur. In most cases, sufficiently large areas can be found in rock bodies wherein the inclinations of the main fractures do not exceed 30° to the horizontal plane. The above conditions apply down to a depth of approximately 300 meters.

At considerably deeper levels of rock, below 300 meters, the vertical principle stress is normally higher than any of the horizontal principle stresses, which during fracturing results in predominantly steep fracture patterns.

In sedimentary types of rock, however, the stress direction is strongly influenced by the layering foliation of the rock, a plane of weakness. This has long been utilized in drilling for oil and in this field a well-developed technique has been worked out for the hydraulic fracturing of deep layers of rock. By applying and regulating the pressure in view of the local conditions, the horizontal or approximately horizontal cracks can be caused to propagate over considerable distances. In the invention, this experience and technical achievements can be utilized to provide a store for heat storage in rock. Preferably, the rock should be igneous or metamorphic and as homogeneous as possible, for example a granite.

The region in which the store is to be placed should also have a low hydraulic gradient. This can be determined by flow tests carried out at the very beginning of the storage construction, before the fracturing of the rock is performed.

According to the invention, the rock is fractured at different levels from one or more production boreholes by applying hydraulic excess pressure at said levels so that a storage volume is obtained comprising a number of approximately plane parallel fractures, the directions of propagation of which are determined by the natural stress state of the rock. Through the hydraulic fracturing, there is the possibility of placing the approximately plane parallel fractures selectively to a great extent at desired levels below ground and with the desired division or spacing between planes. The division is determined by a number of factors such as the heat-conducting capacity of the rock, the temperature of the water to be supplied, the charging time etc. Preferably, however, the fracture planes are placed with a division amounting to between 2 and 20 meters. A thermal energy storage can comprise more than one storage volume, which volume can be arranged side-by-side or consecutively, in series at increasing depths.

The number and/or extension of the fracture planes is determined according to the desired storage capacity of the thermal energy storage. As a rule, geological or other technical conditions do not cause any problems as far as the achievement of the desired fracture plane areas is concerned. According to the demands in different cases the horizontal fractures may have a radial extension up to 200 metres or more around each production borehole. The individual fracture planes can have an area extension ranging between 250 and 20,000 m². Also, the depth below the surface of the ground may be varied as well as the number of fracture planes. The number of fracture planes can be chosen to provide a desired storage capacity, usually measured in kWh, but may also be selected to supply a desired steady-state output, usually measured in kW. Relatively few fracture planes can be used for a thermal storage having a relatively small capacity, but which can supply heat over seasonal time cycles. A higher number of fracture planes can be used for a thermal storage having a relatively large capacity, and which can supply variable amounts of heat both over seasonal time cycles and over relatively short time cycles. The storage capacity is dependent on the total surface area for the thermal energy storage which is selected so that it at least equals the desired storage capacity. According to the invention, the depth below ground level should be at least 25 meters and down to about 300 meters, depending on local conditions.

At least one production hole is drilled down to the bottom of an associated storage volume. The at least one primary or production borehole is connected to a number of secondary boreholes by fracture or fissure plane to permit communication between the secondary boreholes and the at least one production hole at different levels. The mainly parallel fissure or fracture planes may to a certain extent consist of natural cracks or of cracks which spontaneously are formed when the horizontal or approximately horizontal fracture planes are established. The fracture planes can be established by applying hydraulic pressure to a production borehole at selected, suitable levels below ground level.

Through geological exploration, the hydraulic pressure can be applied at the levels which are most favourable from the point of view of the structures and composition of the rock body. The pressure is applied in specifically selected sections of the borehole. For example, the selected section of the production borehole is sealed off above and below the section by sealing sleeves, after which an elevated, controllable hydraulic pressure is applied between the sealing sleeves. Alternatively, the pressure can be applied in a bottom section of a borehole so that the rock is split up starting from this section of the borehole. After that, the hole can be drilled further down, after which the new bottom section is exposed to the hydraulic excess pressure and so on. In one of these ways or by other means which are based on controlled hydraulic fracturing, the mainly plane parallel fracture planes can be caused to extend over large areas, preferably so that the fracture planes extend over the whole width of the store. The number, depth and angle of the secondary boreholes is adapted to the shape of the volume, the required volume of the store, the structures and composition of the rock and the desired flow rate between the secondary boreholes and the at least one production hole. More secondary boreholes can be drilled if required to achieve a desired flow rate towards the at least one production hole and/or to reach a particular fracture plane.

Hydraulic fracturing causes a fracture plane to open up along pre-existing cracks or weakened sections of the rock body, which fracture plane will have an aperture generally measured at right angles to the main extension of the fracture plane. This distance represents a physical or geometric aperture. The aperture of a fracture plane is unlikely to be constant throughout the fracture plane but will vary both in the radial and circumferential direction between a primary borehole and the surrounding secondary boreholes. Consequently, a fracture plane can have a relatively uneven aperture distribution. However, the flow of fluid through a fracture plane is determined by the flow aperture, or effective aperture. The flow aperture is dependent on variations in aperture along the fracture plane, wall roughness and tortuosity. Tortuosity is an intrinsic property of a material usually defined as the ratio of actual flow path length to the straight distance between the ends of the flow path. As in the case of the fracture plane aperture distribution a fracture plane is also likely to have an uneven water flow pressure loss distribution, as the resistance to water flow throughout the fracture plane. At a general level, the flow aperture is calculated based on hydraulic properties of the fracture. Accurate values can be verified by tests and flow measurements. At a detailed level, the flow aperture between a primary borehole and individual secondary boreholes is likely to vary throughout a fracture plane.

The flow resistance is very sensitive to aperture changes, as the flow resistance is proportional to the cube of the aperture. Without flow control, the flow of heated water can mainly only take place within a few fractured planes within the storage volume and/or between a limited number of primary and secondary boreholes within a fractured plane. As a consequence, during charging the heated water would follow the path of least resistance and flow from a primary borehole through a limited number of fracture planes and/or from a primary borehole towards the secondary boreholes through sectors in a fracture plane having a relatively higher flow aperture.

The invention allows this problem to be reduced, if not eliminated, as the flow can be directed to or from specific secondary boreholes, or between specific primary and secondary boreholes.

In order to increase the permeability of fractures and in particular to prevent the fissures and cracks making up a fracture plane from closing again as a result of a reduction of pressure following a hydraulic fracturing process, it is necessary to inject hard particles, or proppants, into the system under pressure to maintain the aperture and to improve the flow aperture. For example, particles can be injected together with the hydraulic fluid in connection with the fracturing. Spacing particles such as quartz are suitable in this connection. To make the introduction of the spacing particles into the fissures and cracks more effective, different fractions of the particles can be introduced together with a lubricant or other substance with similar properties. A number of secondary boreholes are drilled about the at least one production borehole before or after the rock has been fractured. If the store has a moderately large volume only one production borehole is drilled which is placed in the centre. The at least one production borehole is used as a pump hole for discharging fluid during operation of the storage.

When charging of a rock body prepared in the above manner, a heat carrier such as hot water is infiltrated into the cracked storage via one or more primary boreholes during a charging phase. At the same time, relatively colder water is drawn off from the storage through one or more secondary boreholes. Through the relatively fine-mesh network of horizontal or approximately horizontal fissures which have been fractured in the rock body, an effective heat charging of the rock can be brought about with high utilization of the energy content of the hot water. The hot water can be obtained from any suitable source, such as solar collectors, wind power plants, power generating plants, excess/waste heat from industrial facilities or the like. The hot water is introduced into the storage via one or more primary boreholes extending through selected fracture planes of the storage volume associated with the at least one production hole. The flow through the storage volume can be controlled by one or more pumps in the production borehole and/or the secondary boreholes. The hot water can also be forced into the fracture planes by pressurizing the selected boreholes, e.g. by lowering the pressure in the secondary boreholes and/or increasing the pressure in the one or more primary boreholes.

During the discharge of the store, hot water is removed by pumping it out of the at least one production hole or primary borehole. The hot water which is pumped out is replaced by colder water which is introduced through the secondary boreholes in the opposite direction of the flow of water during the charging phase. Similar to the charging process, the hot water can also be drawn out of the fracture planes by pressurizing the selected boreholes, e.g. by increasing the pressure in the secondary boreholes and/or lowering the pressure in the one or more primary boreholes. The discharged hot water can be used in any suitable manner, e.g. for domestic heating or for other purposes, possibly via a heat pump. The pump capacity of the production hole or production holes, the temperature of the charged hot water, the volume of the storage, the thermal capacity of the rock and its heat conducting capacity determine the capacity of the system. Using a thermal energy storage according to the invention, the hydrogeological, thermal and mechanical properties and conditions of the rock are effectively utilized.

Besides heat storage, the same storage as described above can also be used for “cold storage”. In this case, the storage is cooled down by means of cold water during a charging phase, after which the storage is discharged in a similar manner to the preceding examples. This modification of the thermal energy storage according to the invention can be utilized for example to provide cold water for air-conditioning systems in an economically advantageous manner.

The invention should not be deemed to be limited to the embodiments described above, but rather a number of further variants and modifications are conceivable within the scope of the following patent claims.

1.-19. (canceled)

20. A thermal energy storage comprising:
a fluid source comprising one or more primary boreholes where one or more primary boreholes forms an individual well, and/or where one or more primary boreholes contains at least two wells, which primary boreholes extend from ground level to a predetermined depth in a rock body;
two or more secondary boreholes located remote from the fluid source and extending from ground level to a predetermined depth in a rock body;
at least an upper and a lower fracture plane intersecting the one or more primary boreholes and said secondary boreholes, which fracture planes permit a hydraulic flow of fluid between the primary borehole and at least one of the secondary boreholes;
wherein the fluid source comprises a well system comprising at least two wells where each well is in fluid communication with one or more fracture planes;
wherein the well system comprises at least one sealing element positioned to prevent hydraulic flow between wells;
wherein at least one pump is operable to pressurize the fluid and effect a hydraulic flow between one or more primary boreholes and at least one of the secondary boreholes; and
wherein the hydraulic flow in each well and in the at least one of the secondary boreholes is controllable by means of a pump to permit a hydraulic flow of fluid in both directions between one or more primary boreholes and at least one of the secondary boreholes in at least one fracture plane, and which direction is selected for charging or discharging of the thermal storage.

21. Thermal energy storage according to claim 20, wherein the hydraulic flow direction through a fractured plane is determined by at least one pump selected for operation.

22. Thermal energy storage according to claim 20, wherein a pump is arranged in at least one of the secondary boreholes.

23. Thermal energy storage according to claim 21, wherein a pump is connected to at least one of the wells.

24. Thermal energy storage according to claim 21, wherein the at least one pump is a submersible pump.

25. Thermal energy storage according to claim 21, wherein each well is a primary borehole extending past one or more intermediate fracture planes located above the fracture plane or planes with which the primary borehole is in fluid communication, and which well is separated from each intermediate fracture plane by an annular sealing element located level with each intermediate fracture plane.

26. Thermal energy storage according to claim 21, wherein a well comprises a pipe extending past one or more intermediate fracture planes to its respective fracture plane or planes and wherein a sealing element is arranged between the pipe and the primary borehole below the lowermost intermediate fracture plane.

27. Thermal energy storage according to claim 21, wherein the well system comprises at least one pipe extending to two or more fracture planes; and wherein at least one pipe comprises controllable valves each operable to form an individual well in fluid communication with one or more fracture planes which well is separated from other wells in the primary borehole by at least one sealing element arranged between the pipe and the primary borehole.

28. Thermal energy storage according to claim 21, wherein individual wells extending into the primary borehole to one or more fracture planes are separated from other wells in the primary borehole by at least one sealing element arranged between a well comprising a pipe and the primary borehole.

29. Thermal energy storage according to claim 21, wherein a pump in at least one secondary borehole is operable to pump fluid out of its secondary borehole in order to generate a hydraulic flow from a well to at least one of the secondary boreholes.

30. Thermal energy storage according to claim 29, wherein a pump in each secondary borehole is operable to generate a hydraulic flow from the well into an entire fracture plane.

31. Thermal energy storage according to claim 29, wherein the pump in each secondary borehole is selectively operable to generate a hydraulic flow into a sector forming a part of a fracture plane from a well connected to a supply of fluid to each selected secondary borehole.

32. Thermal energy storage according to claim 21, wherein a pump in at least one secondary borehole is operable to pump fluid into the secondary borehole in order to generate a hydraulic flow from at least one of the secondary boreholes to the well.

33. Thermal energy storage according to claim 32, wherein a pump in each secondary borehole is operable to generate a hydraulic flow to the well into an entire fracture plane.

34. Thermal energy storage according to claim 32, wherein the pump in each secondary borehole is selectively operable to generate a hydraulic flow into a sector forming a part of a fracture plane from at least one of the secondary boreholes to a well connected to a receiving means.

35. Method for controlling a thermal energy storage comprising:
a fluid source comprising one or more primary boreholes where one or more primary boreholes forms an individual well, and/or where one or more primary boreholes contains at least two wells, which primary boreholes extend from ground level to a predetermined depth in a rock body;
two or more secondary boreholes located remote from the fluid source and extending from ground level to a predetermined depth in a rock body;
at least an upper and a lower fracture plane intersecting the one or more primary boreholes and said secondary boreholes, which fracture planes permit a hydraulic flow of fluid between the primary borehole and at least one of the secondary boreholes;
wherein the fluid source comprises a well system comprising at least two wells where each well is in fluid communication with one or more fracture planes;
wherein the well system comprises at least one sealing element positioned to prevent hydraulic flow between wells;
the method involving:
controlling the hydraulic flow in a selected direction to or from the one or more primary boreholes by actuating one or more pumps in the well system and/or in one or more secondary boreholes.

36. Method for controlling a thermal energy storage according to claim 35, the method involving controlling the hydraulic flow in at least one well to permit a hydraulic flow of fluid from the well and actuating a pump in at least one secondary borehole to pump fluid out of the secondary borehole in order to generate a hydraulic flow through at least one fracture plane from the well to the at least one of the secondary boreholes.

37. Method for controlling a thermal energy storage according to claim 35, the method involving controlling the hydraulic flow in at least one secondary borehole to permit a hydraulic flow of fluid from the at least one of the secondary boreholes and actuating a pump in at least one well to pump fluid out of the well in order to generate a hydraulic flow through at least one fracture plane from the at least one of the secondary boreholes to the well.

38. Method for controlling a thermal energy storage according to claim 35, the method involving controlling the hydraulic flow in a sector forming a part of a fracture plane between a well and at least one secondary borehole and generating a hydraulic flow in a selected number of secondary boreholes.
